(19) United States
(12) Patent Application Publication
(10) Pub. No.: US 2014/0195261 A1
(43) Pub. Date: Jul. 10, 2014

(54) HEALTH CARE QUALITY PATIENT SATISFACTION SYSTEM

(71) Applicants: Vaishali Rasquinha, New Hyde Park, NY (US); Vandana Kulkarni, Bloomfield Hills, MI (US); Chitranjan Ranawat, Alpine, NJ (US)

(72) Inventors: Vaishali Rasquinha, New Hyde Park, NY (US); Vandana Kulkarni, Bloomfield Hills, MI (US); Chitranjan Ranawat, Alpine, NJ (US)

(21) Appl. No.: 14/147,646

(22) Filed: Jan. 6, 2014

Related U.S. Application Data
(60) Provisional application No. 61/748,986, filed on Jan. 4, 2013.

(51) Int. Cl. G06Q 10/06; G06Q 50/22

(52) U.S. Cl. CPC G06Q 10/0639; G06Q 50/22
USPC 705/2

(57) ABSTRACT

A method and a system are provided for assessing patient satisfaction at each of a plurality of locations in a healthcare facility. The method includes providing patients with access to data input devices at each of the locations in the healthcare facility. Patient input data via the data input devices at each of those locations while the patient is at the respective location. The data is indicative of patient satisfaction of services performed at the respective locations. The data is stored and analyzed to produce reports indicative of patient satisfaction.

### CROSS-REFERENCE TO RELATED APPLICATION

This application claims priority on U.S. Provisional Patent Appl. No. 61/748,986 filed on Jan. 4, 2013, the entire disclosure of which is incorporated herein by reference.

### BACKGROUND OF THE INVENTION

1. Field of the Invention

The invention relates to a system and a method for patient evaluation of health care encounters, patient evaluation of the delivery of health care services by health care providers, and for evaluating patient satisfaction among various health care providers or among different departments in a health care facility so that health care providers can allocate resources for maximizing patient satisfaction.

2. Description of the Related Art

Many personal service professions and businesses periodically try to assess the level of consumer satisfaction with the services that have been received. These efforts typically involve a follow-up telephone call or questionnaire that is received by the consumer of the services several days after the services are performed. The telephone call or questionnaire typically is handled by a consulting company that receives the answers from the recipient of the service, analyzes the answers provided by the recipient of the services, prepares a report based on that analysis and delivers the report to the provider of the services. This typical approach has several drawbacks. First, the consumer typically is asked the questions several days or weeks after the service has been performed. The recollection of the consumer will fade as time elapses. Second, many consumers simply will choose not to respond, and hence surveys of this type have low response rates. Third, there is no certainty that the person responding to the inquiry is the person who actually received the service. Fourth, the service provider is at least one step removed from the raw data and hence has limited ability to consider the raw data or to adjust the algorithm that assesses the raw data to make the raw data more meaningful to the service provider. Fifth, the service provider generally is not capable of making real-time or close to real-time adjustments to these services based on the input from consumers.

The healthcare profession has become increasingly conscious of the importance of considering the input received from patients. However, the healthcare profession has been limited by the above-described methods for assessing consumer satisfaction. There are no commercially available systems or methods that enable providers of healthcare services to receive input from a patient while a service is being performed or immediately after the service is performed. There also are no commercially available systems or methods that enable providers of healthcare services to identify problems in a particular department of a hospital on a real-time basis or close to real-time basis so that problems can be identified immediately and addressed. There also are no commercially available systems or methods that provide a meaningful comparison of one healthcare facility to another healthcare facility.

US Patent Application Pub. No. US 2007/0179805 provides one attempt to address the above-described problems for assessing the level of care provided to a patient. However, the approach taught by US 2007/0179805 does not adequately address all of the above-described problems associated with collecting, analyzing and using consumer satisfaction data in the healthcare profession.

It is an object of the subject invention to provide an improved system and method for assessing patient satisfaction in a hospital or other health care facility and then to use that relevant data for improving the performance within and among healthcare facilities.

### SUMMARY OF THE INVENTION

The invention relates to a system and method for assessing patient satisfaction at each of a plurality of locations in a hospital or other health care facility. The system and method are intended to encompass all health care encounters by recipients of health care services, including both inpatient and outpatient services. The system of the invention may include electronic data input devices that are made available to patients in a hospital or other healthcare facility. For example, the electronic data input devices may include tablet devices or other hand-held electronic devices that may be carried by the patient from one location to another in the hospital or other health care facility. Alternatively, desktop computers, laptop computers, tablet devices, or handheld electronic devices may be available at each location in the hospital at which patient satisfaction is to be assessed. The patient will answer specified questions at each location and that answer will be inputted via the data input device either directly by the patient or with the assistance of healthcare personnel at the specified location. The system will accommodate patient limitations, such patients with vision, speech or hearing impairments, wheelchair-bound patients and the like The inputted data will be transmitted immediately via either a wireless or wired communication system for real-time analysis and reporting to appropriate personnel in the hospital or other health care facility who can affect the quality of the service being provided.

The information collected from each patient initially may include demographic data, such as age, gender, income level and education level and geographic data. The collected information will be coded to identify the hospital or other health care facility and to identify the department within the hospital. The type of information gathered at each hospital or other health care facility preferably is the same to facilitate a meaningful comparison of patient satisfaction with respect to each of a plurality of different criteria. The data collected at a plurality of different hospitals and/or healthcare facilities will be analyzed and returned to each of the healthcare providers so that each hospital or health care facility can assess its own performance over time and compare its performance to other hospitals and healthcare facilities. The analysis preferably addresses each of a plurality of measures of patient satisfaction for each of the departments in each of the hospitals or other health care facilities. The measures of patient satisfaction can relate to the time spent during each phase of a healthcare encounter that is being analyzed, patient comfort while waiting during each phase of a healthcare encounter, clarity and timeliness of explanations given by healthcare personnel, pain, timeliness of medication, cleanliness of the healthcare facility, and such. Patients may be asked to rate each of these possible areas of patient satisfaction on a selected scale, such as a scale from 1 to 5. Each of the analyzed areas of patient satisfaction can be weighted based on a weighting system developed either by the patients or by the healthcare personnel. For example, pain management may be perceived as deserving a higher weight than time spent during admission. Additionally, the weighting applied to each of the analyzed areas of patient satisfaction may differ from one hospital department to another. For example, the time spent by a physician explaining treatment procedures and options may be weighted more heavily in the oncology department than in the orthopedic department. Weighting may initially be performed by the healthcare provider. However, consumer weighting may be carried out as the database grows sufficiently to avoid a skewed weighting effect that could result with a small sample. Consumer input will make the system more reliable over time.

The output can be sorted in accordance with any of the collected demographic or geographic data. Thus, the healthcare provider can determine if efforts to optimize patient satisfaction must be improved in one geographic location as compared to another or from one demographic group as compared to another.

The system and method of the subject invention enables accurate assessments of patient satisfaction to be collected promptly, analyzed immediately and reported to the various hospitals or other health care facilities and various departments of hospitals or other health care facilities in a way that enables performance to be assessed quickly and addressed efficiently, if needed.

### BRIEF DESCRIPTION OF THE DRAWINGS

FIG. 1 is a flowchart illustrating one possible arrangement for collecting and analyzing information from patients to assess patient satisfaction in a hospital.

FIG. 2 is a flowchart illustrating collection, analysis and feedback of information relating to patient satisfaction at each of a plurality of departments within a hospital.

FIG. 3 is a flowchart illustrating collection, analysis and feedback of information relating to patient satisfaction at each of a plurality of hospitals within a healthcare system.

FIG. 4 is a schematic illustration of one possible arrangement of hardware for collecting and distributing information relating to patient satisfaction.

### DETAILED DESCRIPTION OF THE PREFERRED EMBODIMENT

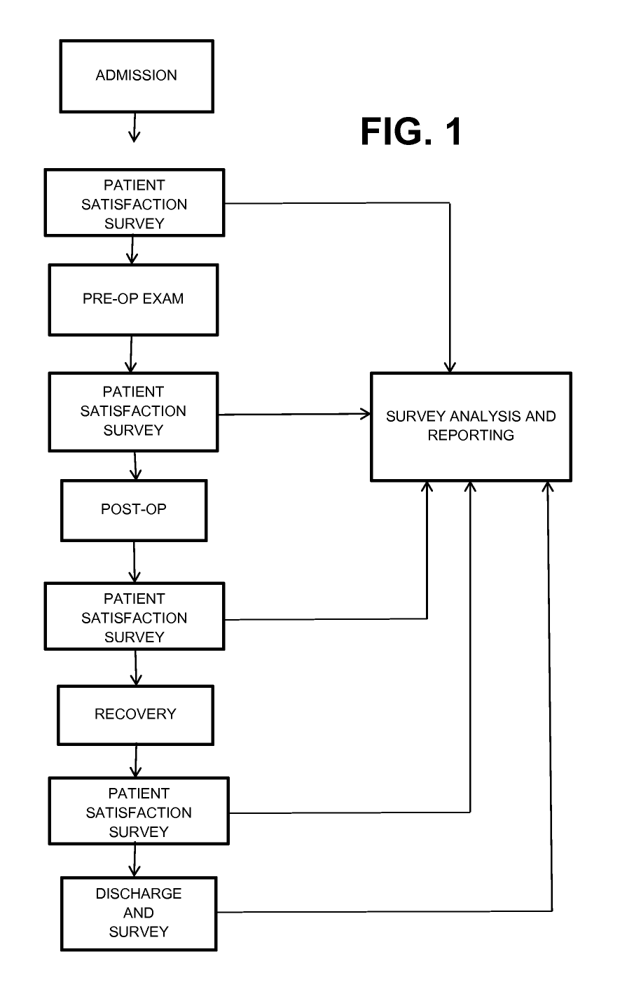

One aspect of the method of the subject invention is illustrated by the flowchart in FIG. 1. More particularly, a patient's ability to report accurately on satisfaction during various stages of a health care encounter, such as a hospital stay, deteriorates dramatically with elapsed time. Accordingly, the method of the invention divides the hospital stay or outpatient visit into stages and requires patients to report on satisfaction during or at the end of each designated stage and before proceeding to the next stage of the healthcare encounter. For example, FIG. 1 illustrates a method where the designated stages of a hospital stay include: admission, pre-op examination, post-op, recovery/rehabilitation and discharge. Data relating to patient satisfaction will be collected during or at the end of each stage and before proceeding to the next stage. The collected data preferably will be transmitted wirelessly to a data collection server that analyzes the collected data immediately and reports on the collected and analyzed data. The collection of data during or at the end of each stage during a health care encounter, such as a stay in a hospital, ensures that various aspects of the health care encounter will be fresh in the mind of the patient and will be reported directly by the patient, not by people who believe they are familiar with the conditions encountered by the actual patient.

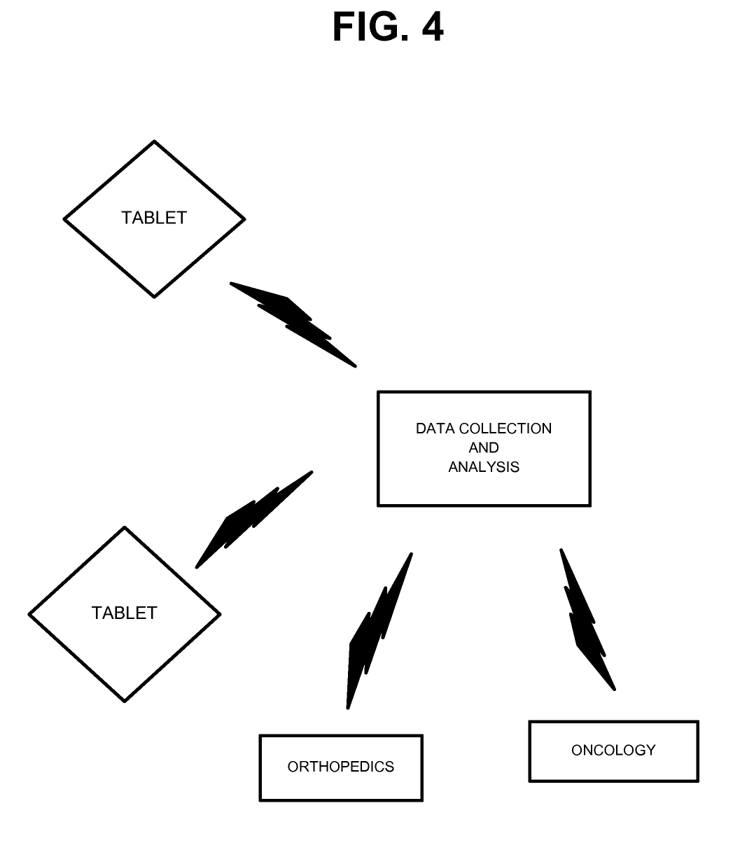

The data preferably is collected by wireless electronic data input devices such as tablet devices, handheld electronic devices or the like, as illustrated schematically in FIG. 4. The data collection and transmission will be carried out with confidentiality and in compliance with standards established by appropriate government and other regulatory agencies The data input devices may be carried directly by the patient or may be associated with a device, such as a wheelchair, via which the patient is transported. Alternatively, the data input devices may be provided at data input stations associated with each designated stage in the hospital or other health care facility. The patient may have the option of inputting data directly or may communicate directly with healthcare personnel at each designated stage in the hospital or other health care facility for purposes of having the patient satisfaction data entered. Either of these optional approaches has the advantage of giving the patient and active involvement in an evaluation of the services that are being provided at each stage in the hospital.

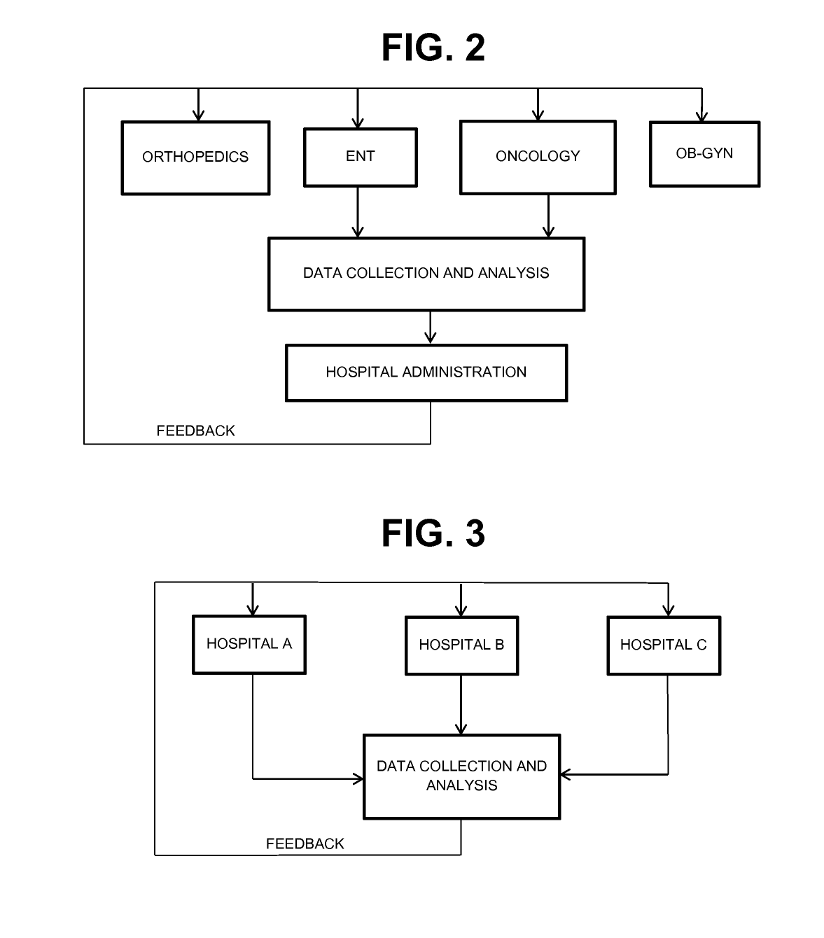

The collected data relating to patient satisfaction preferably is analyzed immediately and fed back to hospital personnel who are in a position to affect the way services are being performed. The inputted data preferably identifies the department of the hospital or other health care facility with which the patient is associated, as shown schematically in FIG. 2. Thus, data may be collected and analyzed separately for orthopedics, ENT, oncology, OB-GYN and such. The collected data may be fed back immediately to these various departments for getting a real-time snapshot of patient satisfaction and for assessing variations in patient satisfaction over time. Even subtle changes in patient satisfaction over time can be identified and procedures can be varied within a department to correct procedures that lead to a reduction in patient satisfaction before those reductions become critical.

Data can be collected from each of a plurality of hospitals and other health care facilities in a specified healthcare system or in a specified geographic area as shown schematically in FIG. 3. The analysis of the collected data then can compare one hospital to another with respect to several measures of patient satisfaction. The analysis can be fed back immediately to the hospitals and other healthcare facilities so that health care providers can analyze their level of performance as compared to other facilities or providers that participate in the patient satisfaction.

Each of the collected data may be given a weight. An absolute value for each aspect of patient satisfaction may be multiplied by a weighting factor. These products of the absolute value times the weighting factor then maybe summed to provide an overall measure of patient satisfaction in the respective department or in the respective hospital so that the departments, hospitals or other providers can be compared to one another. The weighting factors may be developed by hospital personnel or may be developed based on input from patients over time. The following table shows one possible report for a department or hospital.

| Category | Rank | Weighting | Summary |
|---|---|---|---|
| Registration | 80 | 5 | 4 |
| Facility | 89 | 5 | 4.4 |
| Before Surgery | 96 | 40 | 38.4 |
| After Surgery | 89 | 40 | 35.6 |
| Personal Issues | 90 | 5 | 4.5 |
| Overall Assessment | 88 | 5 | 8.8 |
| Total score | | | 95.7 |

The total numeric score can be associated with a more easily appreciated level of patient satisfaction. For example, the numeric scores can be associated with a number of stars, as set forth below.

| Numeric ranking | Star System Ranking | |
|---|---|---|
| 96-100 | ***** | 5 Stars |
| 91-95.9 | **** | 4 Stars |
| 86-90.9 | *** | 3 Stars |
| 81-85.9 | ** | 2 Stars |
| 75-80.9 | * | 1 Star |

The system described above will be perceived by patients as being accurate in view of the high percentage of patients reporting in the survey and the short elapsed time between the receipt of the service and the evaluation of the service. Additionally, the system and method described above will be appreciated by both patients and healthcare providers as a dynamic ranking system that would promote competition across hospitals and other health care facilities for improved patient satisfaction. Furthermore, the system and method of the invention provide a quantitative measure of performance and identify areas where improvement is appropriate, with all of these assessments and analyses being performed on virtually a real-time basis.

What is claimed is:

1. A method for assessing patient satisfaction at each of a plurality of locations in at least one healthcare facility, the method comprising:
providing patients with access to data input devices at each of the plurality of locations in the healthcare facility;
receiving data input by the patients via the data input devices at each of the locations while the patient is at in the respective location, the data being indicative of patient satisfaction with services performed at the respective location;
storing the data input by the patients in a storage device;
analyzing the data stored in the storage device to produce an analysis of patient satisfaction; and
reporting the analysis to at least one location in the healthcare facility or external of the healthcare facility.

2. The method of claim 1, wherein the step of providing patients with access to data input devices comprises providing each patient with a tablet device that is used by the patient at each of the locations and remains at each respective location as the patient moves from one location to another.

3. The method of claim 1, wherein the step of providing patients with access to data input devices comprises providing each patient with a tablet device that is carried by the respective patient from one location to another in the healthcare facility.

4. The method of claim 1, wherein the step of inputting data by the patients comprises inputting answers to questions indicative of patient satisfaction at each of the locations in the healthcare facility.

5. The method of claim 4, wherein the step of inputting answers to questions comprises providing numeric answers indicative of levels of patient satisfaction.

6. The method of claim 1, wherein the step of analyzing the data comprises applying weighting factors to different data entries, the weighting factors being developed by the healthcare facility and/or the patients.

7. The method of claim 1, wherein the step of reporting the analysis comprises sending reports to each location in the healthcare facility.

8. The method of claim 1, wherein the step of reporting the analysis comprises sending reports to administrators of the healthcare facility.

9. The method of claim 1, wherein the at least one healthcare facility comprises a plurality of healthcare facilities, and wherein the step of analyzing the data comprises preparing comparisons of the healthcare facilities, the step of reporting the analysis comprises reporting the comparisons to each of the healthcare facilities.

10. The method of claim 1, wherein the steps of analyzing the data and reporting the analysis is carried out substantially on a real-time basis.

11. The method of claim 1, wherein the locations in the healthcare facility comprise admission, pre-op examination, post-op examination, recovery and discharge.

12. The method of claim 1, wherein the method is carried out and analyzed separately for each of orthopedic, ENT, oncology and OB-GYN departments of the healthcare facility.

13. The method of claim 1, wherein the step of inputting data comprises inputting data relating to clarity and timeliness of explanations given by healthcare personnel, pain, timeliness of medication, and cleanliness of healthcare facility.

14. A system for assessing patient satisfaction at each of a plurality of locations in at least one healthcare facility, the system comprising:
a plurality of data input devices provided respectively at the locations or provided respectively for the patients;
a data transmission network for transmitting data from the respective data input devices;
a storage device communicating with the data transmission network and configured for storing data input by the patients indicative of patient satisfaction at each of the locations;
a data processing unit for analyzing the stored data and outputting patient satisfaction reports.
